(19) United States
(12) Patent Application Publication
(10) Pub. No.: US 2006/0190403 A1
(43) Pub. Date: Aug. 24, 2006

(54) Method and Apparatus for Content Protection and Copyright Management in Digital Video Distribution

(75) Inventors: Xuduan Lin, Fremont, CA (US); Andrew Yam, San Jose, CA (US); Betty Yuan, Union City, CA (US)

Correspondence Address: VIX TECHNOLOGIES INC., 43155 ISLE ROYAL STREET, FREMONT, CA, 94538, US

(73) Assignee: VIX TECHNOLOGIES INC., Fremont, CA (US)

(21) Appl. No.: 11/161,885

(22) Filed: Aug. 20, 2005

Related U.S. Application Data
(60) Provisional application No. 60/522,400, filed on Sep. 25, 2004.

(51) Int. Cl. G06Q 99/00

(52) U.S. Cl. 705/51

(57) ABSTRACT

This patent presents a method, apparatus and system for content protection and copyright management in digital video distribution over packet-based networks. The system consists of a distribution server and its agents. The distribution server first divides a digital video into parts and then processes them into public and control portions. The public and control portions are constructed in such a way that the public portion consists of the majority of the digital video while the control portion consists of only a small fraction of the video and other crucial information for restoring the video to its original format. The public portion is freely distributed without much restriction. In the absence of the control portion, the public portion cannot be decoded for video displaying. Thus, the control portion is delivered to an agent at a premise of authorized subscribers or viewers via a packet-based interactive secured channel at the time of restoring the full-length video content for displaying. An agent, which maintains the interactive secured channel with the distribution server, combines both public and control portions of a digital video back into its original format for displaying.

### RELATED PROVISIONAL PATENT APPLICATIONS

This patent stems from a provisional patent application having Ser. No. US60/522,400, and filing date of Sep. 25, 2004, entitled Method and Apparatus for Content Protection and Copyright Management in Digital Video Distribution, with inventors Xuduan Lin, Andrew Yam, and Betty Yuan. The benefit of the earlier filing date of the provisional application is claimed for common subject matter.

### BACKGROUND OF THE INVENTION

The present invention relates generally to the content protection and copyright management in digital video distribution, particularly through packet based networks such as the Internet. Unlike other methods, the invention employs a unique way to restore the intentionally separated public and control portion of a digital video back to its original format in real-time while the control portion is delivered securely via communication networks during the restoration of the full-length video content for displaying. The invention is an effective method for content copyright protection, yet it requires minimum communication and computation resources while taking advantage of pervasive network access widely available nowadays.

### DESCRIPTION OF THE RELEVANT ART

Digital video, which offers better picture quality and reduces the consumption of distribution resources like bandwidth or spectrum as compares to conventional analog television. As a trend, television broadcasting is moving towards all digital.

At present time, majority of digital videos are distributed via broadcasting media such as cable, satellite and others. Broadcasted digital video is protected by conditional access technology, which encrypts or scrambles digital video in transit.

Conditional access method currently available provides a mechanism to prevent un-authorized viewing, but it is ineffective in protecting the video content and copyright. Besides, proprietary schemes of conditional access for content protection and copyright management are very expensive.

When digital videos are sent via the broadcasting channels, some of the channels may be underutilized, especially during the night, which wastes expensive distribution resources, such as system equipments, networks connections, satellite transponders, cable and off-air spectrum.

The quality of distributed digital video in clear completely matches that of its original master, which permits high quality counterfeiting and re-distribution considering that packet based networks make easy and wide distribution of pirated copies.

With increasing popularity of the Internet and growing capacity of local storage, digital video distributions are in high demand for both service providers and subscribers. As a result, new applications such as video over IP, DVR (digital video recorder), video on demand, etc. are emerging in the market place.

Peer-to-Peer (P2P) is a new application, which enables people around the world to share videos, music and other digital contents over the Internet. With the increase of P2P population, illegal copying video and music using P2P becomes a severe problem. Even though many people have already been sued for P2P copyright infringements worldwide, the P2P copyright infringement is still out of control.

Flexible distribution at low cost, massive but less expensive storage space, secure digital content protection and copyright management are the key elements for digital video to become a mainstream business of providing video services over packet based networks such as the Internet. More digital videos will be made accessible sooner to the subscribers or viewers if copyright can be properly managed and digital video contents can be well protected.

This invention advantageously addresses the above and other needs.

### SUMMARY OF THE INVENTION

The primary object of the invention is a secure solution of strong digital video content protection and effective copyright management.

The second object of the invention is a low cost system for digital video distribution and storage, which enables digital video services such as personalized TV and video-on-demand that allow subscribers or viewers to watch any TV program when they want and pay only for what they watched.

The third object of the invention is a method to use packet based networks, private or public, to deliver digital video services to subscribers or viewers economically and securely.

This invention, as embodied and broadly described herein, is a method and apparatus for secured distribution and copyright protection of digital video. The system, which includes a distribution server and agents, utilizes underneath transport media to distribute digital video. A digital video is accepted and stored in the distribution server Storage Unit 100. The distribution server Processing Unit 150 processes the digital video into the Public Portion 300 and Control Portion 200. It generates a Video List 250 of all managed digital videos in the server. The public portion is freely distributed without much restriction through Broadcasting Networks 310, Broadband Networks 320, or other Media 330. The control portion is delivered to the authorized subscribers or viewers through an Interactive Secured Channel 220 at the time of restoring the full-length video content for displaying. The control portion contains crucial information for recovering the digital video and is processed by Encryption and Conditional Access Control Unit 210. This encryption and conditional access control is under the supervision of Trust Party Authentication Unit 230. A viewing request is received from the Interactive Secured Channel 220 as well.

An agent accepts public portion of a digital video through Broadcasting Networks, Broadband Networks, or Other Media in real time or in advance. The received public portion of a digital video is stored locally in the Local Storage Module 440. An agent sends Viewing Request 420 to the distribution server to establish an Interactive Secured Channel 410. The control portion of the digital video is then delivered through the interactive secured channel and recovered by Decryption Module 430. Video Recovery Module 450 combines the control and public portions to restore the digital video, which is then passed to Video Decoder 460 for displaying throughout the full-length of the video content.

This invention makes majority of a digital video a public portion that is distributed freely in clear. This public portion is constructed in such a way that no video content can be viewed without accessing the control portion. The free distribution makes the public portion to be shared easily, which greatly reduces distribution resources while the clear format saves server processing power tremendously.

The control portion is used as a vehicle to provide content protection and copyright management. It contains a fraction of digital video and critical information of how to restore the original video from public and control portions, and is delivered through a secured interactive channel to the agents.

The system of this invention utilizes an interactive secured channel to authenticate subscribers, perform key exchange and transport vital information. The interactive secured channel requires mere low bandwidth, which is established by using standard communication protocols such as IPset.

Additional objects and advantages of the invention are set forth in part with the description which follows, and in part being obvious from the description, which may be learned through practice of the invention. The objects and advantages of the invention also may be realized and attained by means of the instrumentalities and combinations particularly identified in the appended claims.

### BRIEF DESCRIPTION OF THE DRAWINGS

The accompanying drawings being incorporated, which constitute a part of the specification, illustrate preferred embodiments of the invention and together with the description serve, explain the principles of the invention.

FIG. 1 is a block diagram of the server of digital video distribution system in accordance with the present invention;

FIG. 2 is a block diagram of the agent of digital video distribution system;

FIG. 3 is a block diagram which provides a data flow of digital video processing and distribution presented in this invention;

FIG. 4 illustrates an example of one frame format for transmitting the control and public portions;

FIG. 5 depicts one example of recovering a digital video from the control and public portions;

FIG. 6 illustrates a usage model of broadband networks;

FIG. 7 illustrates a usage model of broadcast hybrid networks;

FIG. 8 illustrates a usage model of other distribution media;

### DETAILED DESCRIPTION OF THE PREFERRED EMBODIMENTS

Reference is made in detail to the present preferred embodiments of the invention, examples of which are illustrated in the accompanying drawings, wherein like reference numerals indicate like elements throughout the several views.

Traditionally videos such as TV programs and movies were captured, processed and broadcasted in analog format to the viewers and subscribers over the airway or wired networks. Analog video does not provide a very good picture quality and is costly to process and distribute. Thus, in order to improve video quality and distribution efficiency, video services are moving to all digital.

Digital video offers better picture quality and makes video content easy to process, store and distribute, which improves the utilization of distribution resources like system equipments, network connections and transport spectrums.

With the increasing popularity of the Internet and broadband access from home, digital videos can be easily distributed through packet based networks. Millions people have downloaded digital videos over the Internet.

With all the benefits listed above, digital video also introduces problems, which prevent video services over packet based networks to become a profitable business. One of the major problems is lack of content protection and copyright management scheme. Illegal copies can be easily distributed and shared over the Internet. Another problem is that distributing digital video over the packet based networks in real time consumes huge amount network bandwidth, which can be very expensive or not even feasible.

Broadcasting industry employs the technology of conditional access, which encrypts digital videos in transit to ensure that only authorized subscribers, or viewers can receive those digital videos. The conditional access provides a mechanism to prevent un-authorized viewing, but it is not very effective in protecting video content and managing the copyright.

Digital video can be easily redistributed. Illegal copying and distributing of digital video have already harmed video and movie industries and become a much more serious problem. A lot of effort has been invested in preventing illegal copying and un-authorized downloading, but the solutions are either too expensive or ineffective.

Conventional video encryption requires a huge amount of processing and computation resources, especially for a network with large number of subscribers for video-on-demand or personalized TV services. Furthermore, proprietary implementation of conditional access increases the cost of service providers.

This invention addresses aforementioned challenges by providing a solution of low cost video distribution with strong content protection and copyright management. A digital video is distributed flexibly in public portion and securely in control portion. Since the public portion does not need to be encrypted, the requirement of heavy processing and computation is eliminated, which enables different flexible distribution methods. Examples are distribution over broadcast, broadband, and wireless networks, distribution through download applications, distribution by DVD/VCD delivery, or even distribution by direct hard drive copying. The control portion is very small and delivered through interactive secured channel, which makes it an ideal solution for content protection and copyright management.

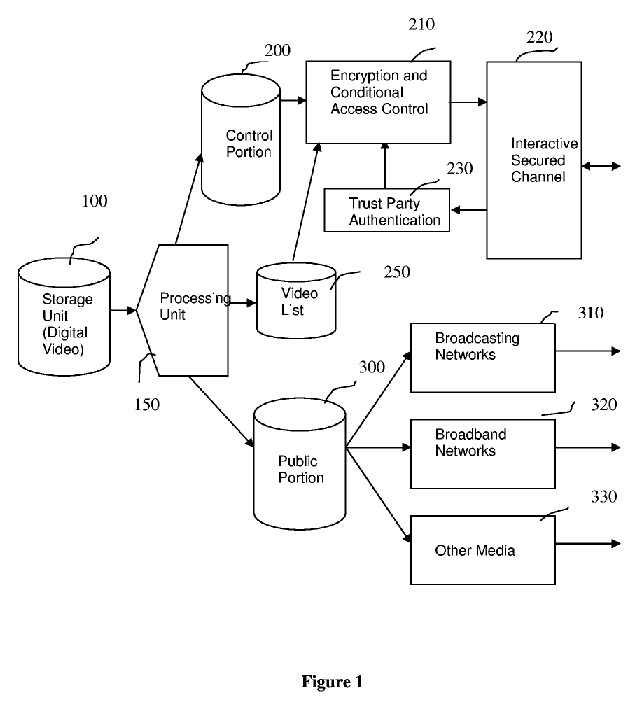

FIG. 1 is a block diagram of the distribution server. The distribution server first accepts a digital video (100) in the format of bit/byte streams, packet frames, or plain files and then processes (150) it into the control portion (200) and public portion (300). The digital video can be in any format such as MPEG-I, MPEG-II, MPEG-IV, DVI, Motion-JPEG, Windows Media Player, Real Player, or other digital formats, as long as it can be processed by a processor (CPU, or other micro processors).

The processing method and algorithm are devised based on the digital format of a digital video. The public and control portions of a digital video together form a distribution set, which defines a digital video. One or more sets can be generated from the same digital video.

The generated public portion is in static format, which requires only one time processing and can be shared by many different subscribers or viewers. Thus, no heavy processing is required by the distribution server.

After applying the selected processing method and algorithm, the public portion consists of the majority, more than 90% in bytes, of a digital video, but it is deemed non-viewable and non-restorable to its original quality by itself.

After applying the selected processing method and algorithm, a control portion contains a small part, less than 10% in bytes, of a digital video and the crucial control information which describes how public and control video portions are connected together. The control portion is the critical element for the restoration of a digital video.

Processed digital videos, the control and public portions, are stored and managed by the distribution server(s). A distribution server generates a managed video list (250), which is also distributed to the agent in menu, Web or other formats.

The public portion normally is freely distributed in clear through broadcast networks (310), broadband networks (320) or other transport media (330).

A viewing request is received via the interactive secured channel (220). The subscriber or viewer is authenticated (230) by the distribution server.

The control portion is encrypted (210) before being sent out and distributed through the interactive secured channel (220) upon the reception of the viewing request.

A trusted party is an authenticated agent on behalf of a subscriber or video viewer.

An interactive secured channel is established using standard communication protocol(s) such as Secured Socket Layer (SSL), IP Security Protocol (Ipsec) or other secured network solutions, which is customized, enhanced or updated with the network configurations, application requirement and other factors. The interactive secured channel only requires low bandwidth.

Standard encryption scheme, such as DES or triple DES is used as the control portion encryption algorithm. Its variation is devised from the standard encryption algorithm to enhance the security upon the application requirements.

The control and public portions do not need to be distributed at the same time.

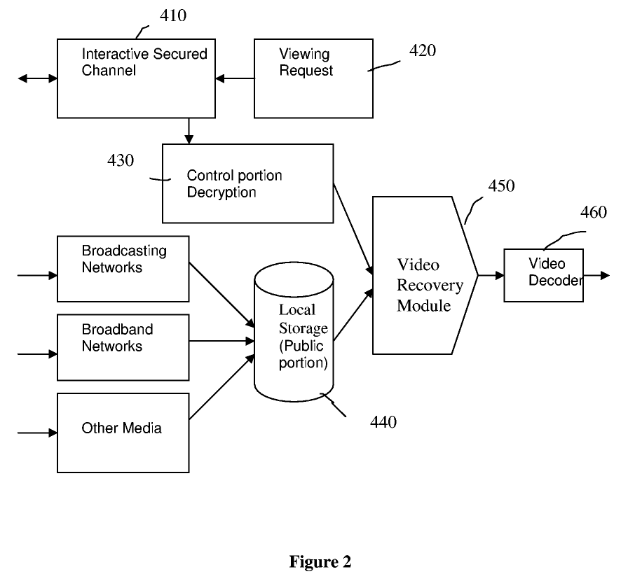

FIG. 2 is the block diagram of an agent. The agent, which interfaces with the distribution server on behalf of subscribers or video viewers, receives and stores the public portion (440) locally. At the time of restoring the full-length video content for displaying, the agent sends a viewing request (420) to the distribution server through the interactive secured channel (410) and maintains the secured channel with the distribution server throughout the complete restoration process.

The agent decrypts (430) received control portion and re-assembles (450) the decrypted control portion with public portion to restore digital video for decoding (460) and displaying. The agent keeps the control portions only in volatile and destroys them once the re-assembling process is completed. It is passed to the decoder for real-time decoding and displaying.

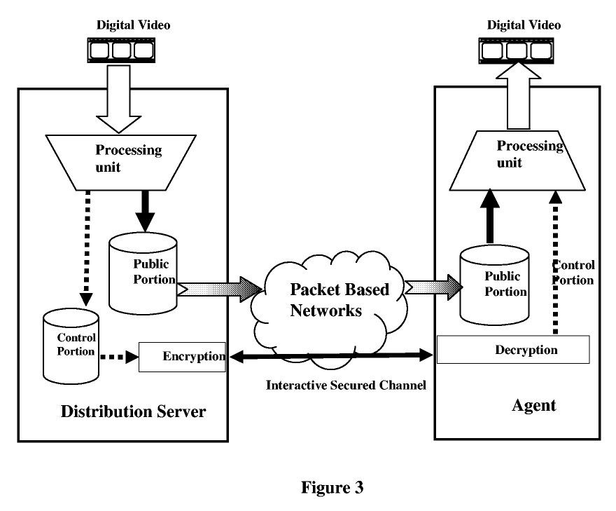

FIG. 3 is a block diagram, which provides a data flow of digital video processing and distribution presented in this invention.

As mention above, the distribution server accepts a digital video and then processes it into the public and control portions. Both public and control portions are stored and managed by the distribution server. A video list is generated as well.

The distribution server distributes the video list to the agent and the subscriber or viewer selects a video from the list. The agent, on behalf of the subscriber or viewer, sends the viewing request to the distribution server

A subscriber or viewer can group one or more video(s) to create a program list. This program list is sent to the distribution server by the agent. The distribution server schedules the delivery of videos in the program list based on the service agreement of the subscriber or video viewer.

The public portion is distributed to the agent in clear over public networks. The agent receives the public portion and stores it locally. Once the public portion is received, the agent notifies the subscriber or viewer.

The control portion is delivered to the agent through an interactive secured channel over the packet based networks. The agent restores the digital video from the public and control portion. The control portion is then discarded once the digital video is decoded or displayed.

The principles of the present invention are equally applicable to the distribution of public and control portions of a digital video through different means, different media and different networks in real time or time shifted manner.

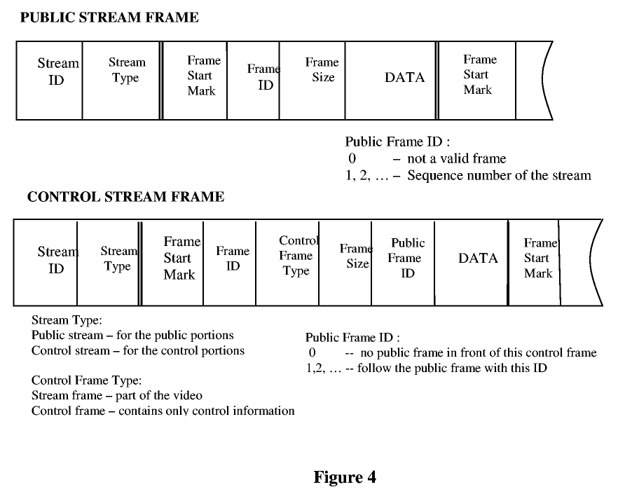

FIG. 4 shows an example of frame format for transmitting the control and public portions.

The stream, which carries the public portion, is called public stream. Each public stream has a stream header and multiple public frames. The frame header contains stream ID and stream type. Stream type can be public stream or control stream. A public frame has four fields. The first three fields are frame start mark, frame ID and frame size. The last field is payload data.

The stream which carries control portion is called control stream. Each control stream has one stream header and multiple control frames. A control frame has fields of frame start mark, frame ID, control frame type, frame size, public frame ID and payload data. Control frame type indicates payload data type, which can be video data that is part of a video, or management data. A public frame ID links public and control stream together.

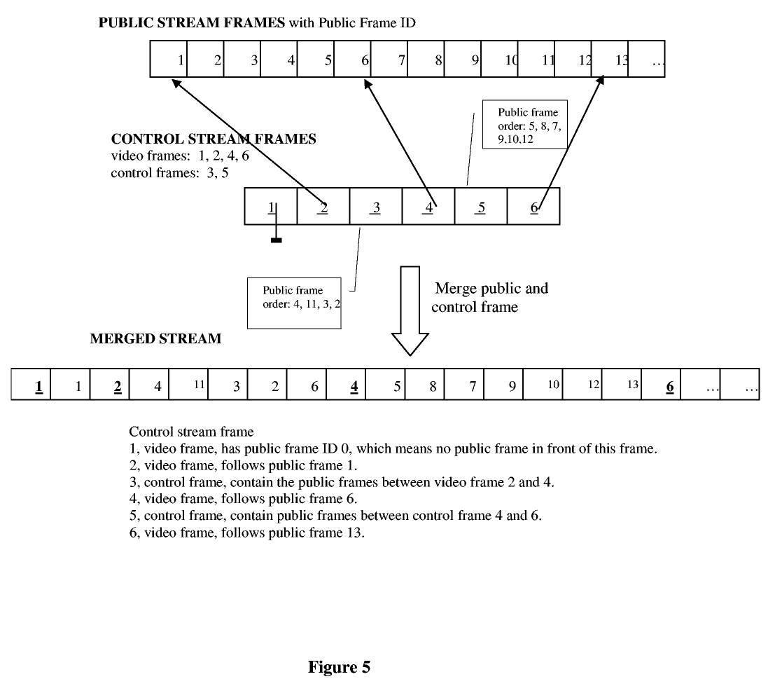

FIG. 5 shows one example of recovering a digital video from the control and public portions.

The frame order in public stream can be the same as its original video stream or scrambled for a better protection result. The format of public portion is detailed in control stream. In this diagram, control stream has four video frames which are frame ID 1, 2, 4 and 6, and two control frames which are frame 3 and 5.

Control frame 1, a video frame, has public frame ID 0, which indicates no public frame in front of this frame. The frame 2, also a video frame, follows public frame 1. The frame 3, a control frame, describes which public frames should be inserted here and in what order. In this case, public frames 4, 11, 3 and 2 are inserted in order. Frame 4 is another video frame which brings public stream frame 6 in front of it. Frame 5 is a control frame that brings in public video frame 5, 8, 7, 9, 10, 12, and finally, frame 6, a video frame, has public stream frame 13 inserted ahead of itself. The merged stream is shown at the bottom of the picture.

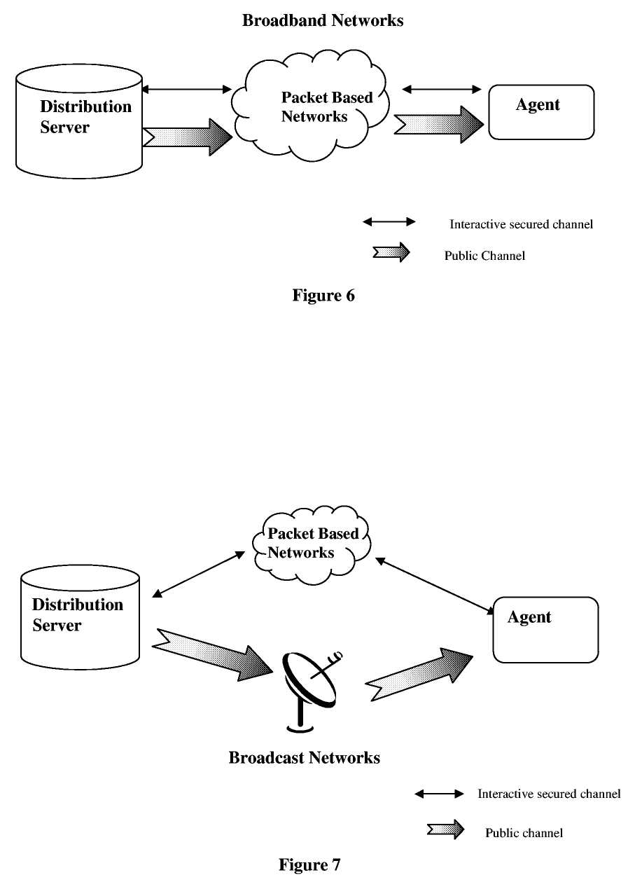

FIG. 6 shows a usage model of broadband networks.

The agents are connected to a distribution server over packet based networks such as the Internet. The public and control portions are distributed in the same channel or in different channels.

FIG. 7 shows a usage model of broadcast hybrid networks.

Distribution server and agent are on broadcast hybrid networks: the public portion is transported through a broadcast networks such as Cable TV, Satellite, or others. The control portion is transported through packet based interactive networks such as the Internet.

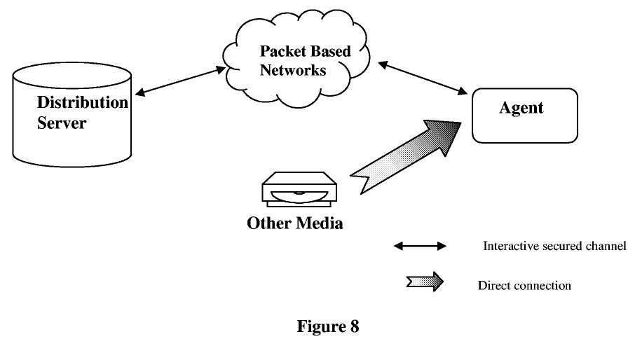

FIG. 8 shows a usage model of other distribution media.

The public portion is distributed in various media such as VCD, DVD, etc.

The video play-out device has a connection to the network which links to a distribution server.

The advantages of this invention include: (1) Digital video copyright management and content protection: A digital video is distributed with public and control portions and can be protected solely by its control portion, which contains part of the video and critical control information and is distributed through an interactive secured channel only to the trusted party. Without control portion, the video cannot be decoded or displayed; (2) Low distribution cost: The public portion can be freely distributed through packet based networks or other distribution means while the control portion transmission requires only a low bandwidth channel. Public portion can be shared by different service providers with matching control portions to reduce the delivery cost of public portion; (3) Flexible network configuration: Service providers can use broadband networks and broadcast hybrid networks to provide video services; (4) Reduced processing cost: The public portion of video does not need to be encrypted which will drastically reduced the requirement of server computing resources; (5) Utilization of unused bandwidth: The bandwidth of non peak time can be used to distribute the public portion; (6) Extendable architecture: it enables enhanced video services such as video on demand and personal TV.

It will be apparent to those skilled in the art that various modifications can be made to the method and apparatus of the instant invention without departing from the scope or spirit of the invention for content protection and copyright management in digital video distribution. And it is intended that the present invention covers modifications and variations of the method and apparatus for content protection and copyright management in digital video or other digital content distribution provided they come within the scope of the appended claims and their equivalents.

What is claimed is:

1. A system for content protection and copyright management in digital video distribution comprising: a distribution server and its agents utilizing underneath transport media to transport digital videos; the distribution server divides a digital video into parts and then processes them into the public and control portions; the distribution server manages both public and control portions and delivers them to its agents per request; the server establishes a low bit rate and packet-based interactive secured channel by using standard communication protocols with the requesting agents to authenticate subscribers and transmit the control portion; the agents access to both public and control portions; the agents recover the full-length digital video for decoding and displaying.

2. The system as set forth in claim 1, the distribution server distributes videos in digital format to the agents.

3. The system as set forth in claim 1, the public portion consists of the majority, more than 90% in bytes, of a digital video.

4. The system as set forth in claim 1, the public portion is constructed in such a way that it cannot be displayed or viewed meaningfully without its control portion.

5. The system as set forth in claim 1, the control portion contains only a fraction, less then 10% in bytes, of a digital video.

6. The system as set forth in claim 1, the control portion is constructed with the critical information which binds both public and control portion together for recovering a digital video.

7. The system as set forth in claim 1, content protection and copyright management of digital videos rely on the accessibility of their control portions.

8. The system as set forth in claim 1, an interactive secured channel is used to authenticate subscribers by the distribution sever and agents. The interactive secured channel is established by using standard communication protocols.

9. The system as set forth in claim 1, an interactive secured channel is used to perform key exchange by the distribution sever and agents. The key exchange scheme is devised by using standard protocols or enhanced methods.

10. The system as set forth in claim 1, an interactive secured channel is maintained by the distribution sever and agents for the secure delivery of the control portions at time of restoring the full-length video content. The control portions are encrypted using standard or enhanced encryption algorithms.

11. The system as set forth in claim 1, the low bit rate interactive secured channel for subscriber authentication and access authorization of the control portion in the video restoring process enables flexible content protection and copy right management in networks available for personalized video services.

12. A method for secured distribution of digital video, comprising the steps of: generating public and control portions of a digital video; distributing public portion through any channel; encapsulating the control portion data; authenticating subscribers, securely transmitting and protecting the control portion data; accessing public portion, receiving control portion data at the video restoring stage and processing public and control portions to deliver decoded video for displaying, all by agent unit.

13. The method as set forth in claim 12, the content protection and copy right management is achieved through the accessibility of a small amount of special data subtracted from the digital video and control information.

14. The method as set forth in claim 12, the distribution server unit processes digital videos into public and control portions. The public portion is freely distributed without much restriction through various means such as satellite, cable, the Internet, DVD, and etc. The control portion is distributed to the authorized subscribers through an interactive secured channel at time of restoring the full-length video content.

15. The method as set forth in claim 12, with the agent unit receives the control portion in the real time interactively. The agent unit keeps the control portion in volatile and destroys it after the video is restored for displaying.
